(19) United States
(12) Patent Application Publication
(10) Pub. No.: US 2006/0225664 A1
(43) Pub. Date: Oct. 12, 2006

(54) Animal exerciser, educator, feeder, and toy

(76) Inventor: Ann Sheri Zych, Montville, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/099,873

(22) Filed: Apr. 6, 2005

(51) Int. Cl. A01K 31/12

(52) U.S. Cl. 119/537

(57) ABSTRACT

A method and apparatus for efficiently and effectively exercising, educating, amusing, and feeding animals is disclosed. In one aspect of the invention, the apparatus encourages an animal to access educational, recreational, exercise, and amusement devices by configuring the apparatus such that the animal is most comfortable when it is eye level with the devices. Additionally, defecation on such devices and food or water receptacles is minimized due to strategic placement of such devices in relation to the comfortable setting of the animal. In another aspect of the invention, educational, recreational, exercise, and amusement devices are provided that also provide the animal with feelings of accomplishment and productivity. Embodiments of the present invention are specifically designed for the size of the animal and include lightweight, easily cleaned materials that facilitate transportation and cleaning of the apparatus.

### BACKGROUND OF THE INVENTION

Embodiments of the present invention generally relate to aids for efficiently and effectively exercising, educating, feeding, and amusing animals. More specifically, the present invention relates to apparatus and methods for exercising, educating, amusing, feeding, and watering an animal or several animals while simultaneously preventing the animal from defecating on its toys or food.

Many systems and methods have been created to amuse animals such as birds. Many such systems are suspended systems. Typically, these suspended systems are suspended from the top of the animal's cage or a ceiling or other overhead fixture above the animal's cage via a universal joint or other fastener. Such systems typically include one or more suspended chains or the like to which amusement devices are attached. In one form, a length of suspended chain contains any number and variety of bells, beads, mirrors, blocks, rawhide chew toys, sitting rings, gongs, plastic baby toys, balls, sticks, leather straps, lengths of hemp, and eucalyptus attached to individual chain links. In other similar systems, a suspended chain is coupled to only the uppermost component, and all subsequent components are connected to each other. Or, systems exist in which all components are connected to a suspended chain located through the center of each component.

One such suspended amusement system includes audible amusement. In this system, chimes are attached to a ceiling out of the animal's reach. An animal attractant, such as a toy or feed, is coupled to the chimes and functions as a striker that activates the chimes whenever the animal accesses the animal attractant.

Some existing suspended systems are designed to both feed and amuse the animal. For example, in one such system, food with limited access (e.g., the food is contained within a box with slots or holes) is attached to the bottom of a suspended chain and amusement devices are suspended above the food.

In addition to amusement and feeding systems, systems exist for exercising animals. In some such systems, a plurality of perches are arranged to allow the animal to climb in one or more directions. In one such system, two circular perches are aligned such that when an animal rests on the top of one of the circular perches, the portion of the perch upon which the animal is resting rotates to the bottom position, encouraging the animal to move to the second circular perch, which is simultaneously returning to the top position. Another existing exercise system contains straight and C-shaped rods that can be configured by the animal's owner in any desired arrangement within the animal's cage to allow the animal to move about the cage via the various rods.

Many existing exercise, amusement, and feeding systems have been designed for portability. One such system includes various detachable plastic perches that can be easily inserted horizontally at different locations in a main vertical rod. Another system is designed to fold within the base of the animal's cage. This system includes a lid that may be attached to the base during use of the cage and may be placed on top of the base during travel or storage to cover and protect the cage in its folded position.

### SUMMARY OF THE INVENTION

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

An animal apparatus for efficiently and effectively exercising, amusing, feeding, and watering one or more animals such as a bird while preventing the animal from defecating on its devices or food is provided in one aspect of the present invention. In one embodiment of the present invention, the animal apparatus includes, inter alia, a platform, barriers, perches, receptacles, ladders, a device supporter, and devices such as toys and the like.

The platform serves as a base for the other components of the animal apparatus as well as a walkway that allows an animal such as a bird, ferret, hamster, rabbit, gerbil, guinea pig, cats, etc. to travel between the components of the animal apparatus. Barriers surround the perimeter of the platform to encourage animals to stay within the confines of the barriers and to hinder debris such as feed, water, feces, etc. from falling from the surface of the platform. Preferably, the platform and barriers are fabricated from a material that facilitates cleaning of the platform and barriers.

One or more device supporters may be attached to the platform. The construction of the device supporters is a critical aspect of the present invention in view of the fact that domesticated animals tend to follow the same hierarchy or “pecking order” that they would in nature. For example, in reference to birds, this pecking order corresponds to the level at which each bird is perched, for example, in a tree. The higher the bird is in the pecking order, the higher the bird will perch in the tree. Furthermore, birds are prey animals, which, unlike dogs or cats, have not been fully domesticated. Therefore, birds naturally will seek a high location to perch due to nervousness about being preyed upon.

This instinctual pecking order and nervousness regarding being preyed upon causes domesticated birds to perch at the highest point available to them, often causing these birds to perch at the highest available point in a playgym, birdcage, etc. However, this manner of perching may cause many problems. For example, an animal perched at the highest available point may not be able to reach its educational, exercise, or amusement devices; therefore, it will forego education, exercise, or amusement to retain its pecking order. In addition, when an animal perches at the highest point, it tends to defecate on devices such as educational, exercise, or amusement devices located below the animal. After such devices are dirtied, animals are even less likely to play with such dirty devices and have less incentive to perch at lower levels of the playgym, cage, etc. Additionally, the animal's owner may not be pleased with an animal that continually defecates on or does not use its devices, causing further stress on the animal due to scolding for its “bad behavior”. Furthermore, similar to humans, animals that are not occupied via exercise, play, or education tend to become unhappy, which may result in bad behavior such as biting, incessant squawking, etc. Unbeknownst to the animal owner, all of these issues may be alleviated by providing the animal with properly configured play, education, or exercise areas such as those provided by the present invention. In the various embodiments of the present invention, a principle advantage of the invention is to create an enjoyable environment for animals where they may entertain themselves while being physically exercised and intellectually stimulated, thus contributing to the overall health and well-being of the animal and, consequently, the satisfaction of the pet owner.

Preferably, since the device supporters are located at a point higher than the perches (i.e., to place the devices at eye level), they are advantageously designed to be an extremely uncomfortable and unsettling place for the animal to perch. Therefore, the animal is likely to rest on the second highest points, which are designed to be perches or ladders. These second highest points are advantageously located to place the animal at eye level when perched upon the perches or ladders and to prevent the animal from defecating on or in the receptacles or devices, thereby increasing the likelihood that the animal will use the receptacles and devices and increasing the owner's satisfaction with the animal.

Devices may be removably attached to the device supporter via a wide variety of fasteners. In one embodiment of the present invention, fasteners are clasps or hooks that allow the user to remove or replace devices with ease. Fastener could include clasps such as hook and eye, barrel, tube, round, pear link, quick link, or fishhook, but preferably would avoid lobster claw and toggle clasps to minimize the possibility of injury to the animal due to contact with the clasp. Alternatively, fasteners could be an irremovable ring, and the horizontal portion of device supporter could contain components that allow the user to remove or add devices. Fasteners may be fabricated of any rigid material, however, a non-toxic material such as a nickel-plated material, aluminum, stainless steel, or nylon is preferred for increased safety to the animal.

The embodiments of the present invention may contain any quantity of devices. Devices may consist of any arrangement of amusement, exercise, or education devices such as plastic or acrylic chains, vegetable tanned leather squares, leather circles or straps, marbella beads, wooden blocks, plastic or acrylic keys, plastic or acrylic letters or numbers, plastic or acrylic beads, food colored sticks, wood circles or squares, plastic chewy tubes, paper tape such as adding machine tape, bells, plastic novelty animals, paper rolls, and the like. Preferably, the components of the devices are constructed of lightweight, non-toxic materials such as soft wood, leather, paper, soft cotton rope, or soft plastic to stimulate and encourage the animal to play. In some embodiments of the present inventions, the components of the devices are dyed using a variety of food colorings to safely make the components more attractive to the animals.

Although devices may include any combination of the items described above, the inclusion of devices that can be destroyed by the animal such as paper rolls, wood, etc. is an important aspect of the present invention. The destruction of the devices occupies, stimulates, and provides the animal with a feeling of productivity and achievement, thereby creating a happier and more well behaved pet. Therefore, preferably, these devices or the components thereof are assembled such that each component may be replaced since the animal may regularly destroy it during use of the playgym, cage, etc.

In some embodiments of the present invention, roll devices are included. Roll devices may be constructed so that paper, newspaper, paper tape such as adding machine tape or other similar material wound around a moveable roll can be ripped or torn off of the roll by the animal. The destruction of the paper, newspaper, paper tape such as adding machine tape, or other material on the paper rolls gives the animal a feeling of productivity and achievement. Similarly, other components of devices such as wooden blocks, plastic toys and keys are constructed of disposable materials that can be destroyed by the animal to obtain the same feelings of productivity and achievement. The components of device are assembled such that each component could be replaced if destroyed by the animal during use.

Some embodiments of the present invention also include tree devices. Tree devices may be constructed of many devices attached to various branches of the tree. Tree devices allow the animal to have access to many different components of devices at one location. In one aspect of the present invention, the tree device rotates, thus allowing the animal easy access to the various facets of the device.

In many embodiments of the present invention, the animal apparatus facilitates physical exertion by the animal due to the location of the various components of the animal apparatus and their proximity to each other. For example, the animal may be required to climb up one ladder in order to eat food from its respective receptacle, and then the animal must climb down that ladder, walk across the platform, and then climb up another ladder in order to drink water from its respective receptacle. Similarly, the animal is required to walk across the platform in order to reach a perch located directly in front of the devices. Additionally, the animal apparatus may be configured so as to include educational devices specifically designed for the purpose of training and educating the animal. Such activity by the animal provides exercise, training and entertainment for the animal and adds to the functionality of the present invention.

Although embodiments of the present invention in the form of an avian playgym, the present invention is not so limited. For example, the present invention may be configured for use by alternate animals by incorporating devices such as animal cages or other animal play or exercise devices such as Habitrail®, vivarium, or terrarium devices, or connection hardware for such devices. Alternatively, the components of the present invention may be configured so that the present invention may be joined to, or combined with, one or more units of the present invention, or similarly compatible apparatuses, so as to create a larger or more complex apparatus.

### BRIEF DESCRIPTION OF THE DRAWINGS

A further understanding of the present invention can be obtained by reference to embodiments set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts an animal apparatus in accordance with one embodiment of the present invention intended for small animals including, inter alia, platform, barriers, perches, receptacles, ladders, device supporter, and devices.

FIG. 2 depicts an animal apparatus in accordance with one embodiment of the present invention intended for large animals including, inter alia, platform, barriers, perches, receptacles, ladders, device supporter, devices, and a tree device.

### DETAILED DESCRIPTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of one embodiment (as well as some alternative embodiments) of the present invention.

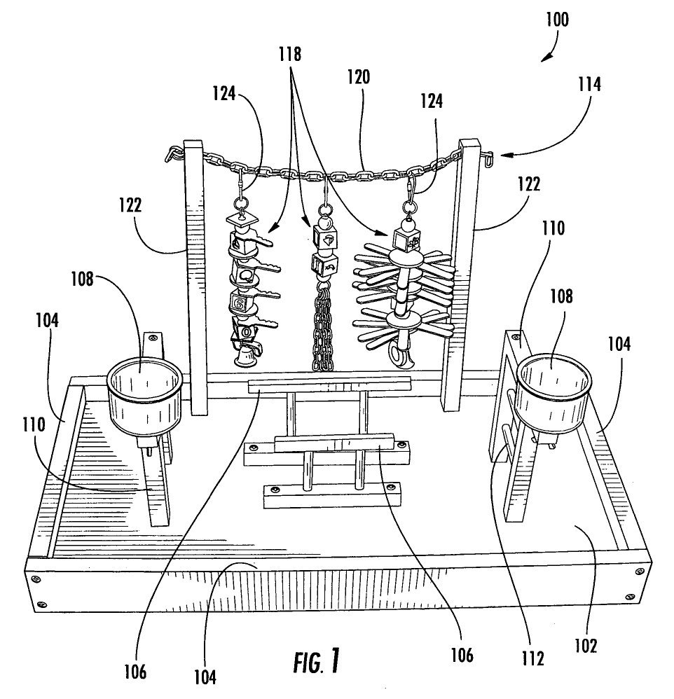

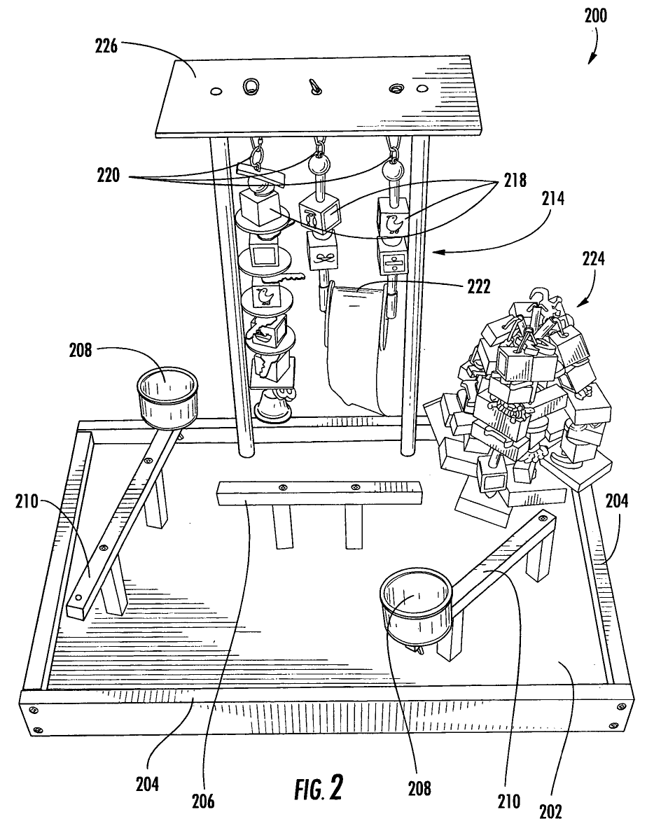

Referring first to FIG. 1, illustrated is an illustration of one embodiment of animal apparatus 100 in accordance with embodiments of the invention. Animal apparatus 100 includes, inter alia, platform 102, barriers 104, perches 106, receptacles 108, ladders 110, device supporter 114, and devices 118.

Platform 102 serves as a base for the additional components of animal apparatus 100 as well as a walkway that allows an animal such as a bird, ferret, hamster, rabbit, gerbil, guinea pig, cats, etc. to travel between the components of animal apparatus 100. Platform 102 may be fabricated of any rigid material, however, forming platform 102 from a material such as Formica®, granite, Corian®, plastic, or the like facilitates cleaning of platform 102. In the embodiment of the present invention depicted in FIG. 1, barriers 104 surround the perimeter of platform 102 to encourage animals to stay within the confines of barriers 104. Barriers 104 also hinder debris such as feed, water, feces, etc. from falling from the surface of platform 102.

In one embodiment of the present invention, either or both of platform 102 and barriers 104 include two layers. A first outwardly facing support layer (e.g., wood, plastic, etc.) is coupled to a second inwardly facing layer of easily cleaned material (e.g.—Formica®, granite, Corian®, plastic). In this embodiment, the support layers are fabricated from a lightweight material such as wood or plastic to add structural support to platform 104 while simultaneously reducing the weight of animal apparatus, thereby facilitating transportation.

Device supporter 114 is attached to platform 102. The construction of device supporter 114 is a critical aspect of the present invention in view of the fact that domesticated animals tend to follow the same hierarchy or “pecking order” that they would in nature. For example, in reference to birds, this pecking order corresponds to the level at which each bird is perched, for example, in a tree. The higher the bird is in the pecking order, the higher the bird will perch in the tree. Furthermore, birds are prey animals, which, unlike dogs or cats, have not been fully domesticated. Therefore, birds naturally will seek a high location to perch due to nervousness about being preyed upon.

This instinctual pecking order causes domesticated birds to perch at the highest point available to them, often causing these birds to perch at the highest available point in a playgym, cage, etc. However, this manner of perching may cause many problems. For example, an animal perched at the highest available point may not be able to reach its educational, exercise, or amusement devices; therefore, it will forego education, exercise, or amusement to retain its pecking order. In addition, when an animal perches at the highest point, it tends to defecate on devices such as educational, exercise, or amusement devices located below the animal. After such devices are dirtied, animals are even less likely to play with such dirty devices and have less incentive to perch at lower levels of the playgym, cage, etc. Additionally, the animal's owner may not be pleased with an animal that continually defecates on or does not use its devices, causing further stress on the animal due to scolding for its “bad behavior”. Furthermore, similar to humans, animals that are not occupied via exercise, play, or education tend to become unhappy which may result in bad behavior such as biting, incessant squawking, etc. Unbeknownst to the animal owner, all of these issues may be alleviated by providing the animal with properly configured play, education, or exercise areas such as those provided by the present invention.

In the various embodiments of the present invention, a principle advantage of the invention is to create an enjoyable environment for animals where they may entertain themselves while being physically exercised and intellectually stimulated, thus contributing to the overall health and well-being of the animal, and consequently the satisfaction of the pet owner. The present embodiment of the invention facilitates physical exertion by the animal due to the location of the various components of the apparatus 100 and their proximity to each other. For example, the animal is required to climb up one ladder 110 in order to eat food from its respective receptacle 108, and then the animal must climb down that ladder 110, walk across platform 102, and then climb up another ladder 110, in order to drink water from its respective receptacle 108. Similarly, the animal is required to walk across platform 102 in order to reach a perch 106 where the animal can play with devices 118. Additionally, apparatus 100 may be configured so as to include devices 118 specifically designed for the purpose of training and educating the animal. Such activity by the animal provides exercise, training and entertainment for the animal and adds to the functionality of the present invention.

In the embodiment of the present invention depicted in FIG. 1, device supporter 114 includes device bar 120 supported by two device bar stands 122. In this embodiment, device bar 120 comprises plastic links that form a horizontal chain supported on either end by each of device bar stands 122. Device bar 120 is advantageously designed to be an extremely uncomfortable and unsettling place for the animal to perch since device bar 120 is unstable and unsteady. Device bar 120 is intentionally designed to cause the animal to be anxious when standing upon it. Since the animal is unlikely to feel comfortable perching atop device bar 120 of device supporter 114, the animal is likely to rest on the second highest points, which include perches 106 or ladders 110. These second highest points are advantageously designed to prevent the animal from defecating on receptacles 108 or devices 118, thereby increasing the likelihood that the animal will use receptacles 108 or devices 118 and increasing the owner's satisfaction with the animal.

Although the embodiment of the present invention depicted in FIG. 1 includes a device supporter 114 having device bar 120 constructed of plastic links, other types of device supporters may be incorporated without departing from the scope of the present invention. Virtually any device that supports devices and is uncomfortable as a perch can be substituted. For example, the device bar may be made of a material other than plastic and may comprise a form other than chain links. In one embodiment, the horizontal portion of device supporter 114 is constructed of a slippery material such as rigid vinyl, acrylic, or ultra high molecular weight polyethylene that would cause the animal to be anxious standing upon it. Alternatively, the horizontal portion of device supporter 114 could be constructed of any material having a texture that would be unpleasant to the animal. In yet another embodiment, the horizontal portion of device supporter 114 is constructed to be too thin for an animal to grasp without falling. In still another embodiment, device supporter 114 does not include a horizontal portion at all. Rather, it comprises individual vertical stands, posts, or the like for each device 118 having a top with an extremely small area that is not suitable to perching. In addition, although device supporter 114 is depicted in FIG. 1 as three distinct components, other embodiments are envisioned in which device supporter 114 comprises one continuous piece or a quantity other than three.

Devices 118 are attached to device supporter 114 via fasteners 124. In one embodiment of the present invention, fasteners 124 are clasps or hooks that allow the user to remove or replace devices 118 with ease. Fastener 124 could be any variety of clasp such as hook and eye, barrel, tube, round, pear link, quick link, or fishhook, but preferably would avoid lobster claw and toggle clasps to minimize the possibility of injury to the animal due to contact with the clasp. Alternatively, fasteners 124 could be a ring that is not removable, and the links of the chain that form the horizontal portion of device supporter 114 could contain components that allow the user to remove or add devices 118. Fasteners 124 may be fabricated of any rigid material, however, a non-toxic material such as a nickel-plated material, aluminum, stainless steel, or nylon is preferred for increased safety to the animal.

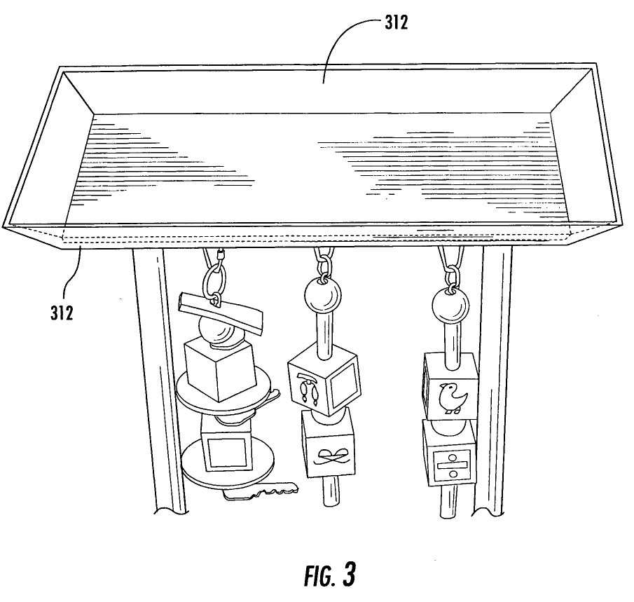

In the embodiment of the present invention depicted in FIG. 1, device supporter 114 contains three devices 118. Devices 118 may consist of any arrangement of amusement, exercise, or education devices such as plastic or acrylic chains, vegetable tanned leather squares, leather circles or straps, marbella beads, wooden blocks, plastic or acrylic keys, plastic or acrylic letters or numbers, plastic or acrylic beads, food colored sticks, wood circles or squares, plastic chewy tubes, paper tape such as adding machine tape, bells, plastic novelty animals, paper rolls, and the like. Preferably, the components of devices 118 are constructed of lightweight, non-toxic materials such as soft wood, leather, paper, soft cotton rope, or soft plastic to stimulate and encourage the animal to play. In some embodiment of the present inventions, the components of devices 118 are dyed using a variety of food colorings to safely make the components more attractive to the animals. While this embodiment contains three devices 118, any other quantity of devices 118 could be attached to device supporter 114 without departing from the present scope of the invention. Although devices 118 may include any combination of the items described above, the inclusion of devices 118 that can be destroyed by the animal such as paper rolls (e.g., roll device 222 (FIG. 2)), wood, etc. is an important aspect of the present invention. The destruction of devices 118 occupies, stimulates, and provides the animal with a feeling of productivity and achievement, thereby creating a happier and more well behaved pet. These devices 118 or the components thereof are assembled such that each component may be replaced since the animal may regularly destroy it during use of the playgym, cage, etc.

In one embodiment of the present invention, two perches 106 are attached to platform 102 but other quantities of perches 106 could be attached to platform 102 without departing from the scope of the present invention. Preferably, perches 106 are located at the highest comfortable height and at a height that places the animal at eye level with devices 118 when the animal is seated atop perch 106. To achieve this aim, animal apparatuses are preferably designed to match the height or average height of the intended animal. For example, an animal apparatus designed for extra small birds such as parakeets, canaries, finches, budgerigars, small lovebirds, and small parrotlets would not be suitable for small birds such as cockatiels, parrotlets, lovebirds, caiques, small conures, and meyers parrots, medium birds such as African greys, amazons, pionus, goffin cockatoos, rose-breasted cockatoos, or large birds such as macaws, umbrella cockatoos, moluccan cockatoos, and the like. Preferably, each animal apparatus is designed for the specific size of the intended animal.

In one embodiment of the present invention, two ladders 110 are attached to platform 102. However, other quantities of ladders 110 could be attached to platform 102 without departing from the spirit of the present invention. Ladder 110 includes two rungs 112 for the animal to climb upon in this embodiment of the present invention. Other embodiments envision ladder 110 with varied quantities of rungs 112. Preferably, ladders 110 are located at a height that allows the animal to be at eye level with devices 118 when the animal is seated atop ladders 110. Attached to the top of ladders 110 are receptacles 108. Receptacles 108 are intended to hold food and water for the animal to access while it is perched atop ladders 110. Receptacles 108 could be attached to a perch or similar structure other than ladders 110 without departing from the scope of the present invention.

Positioning of perches 106 and ladders 110 such that an animal perched atop either item is at eye level with its devices is an important aspect of the present invention. Since the animal will instinctually perch on the highest point available, devices 118 must be at eye level to encourage the animal to use devices 118. The animal is unlikely to reduce its rank in the pecking order or to increase the chances of being preyed upon to gain access to devices 118 if they are positioned below the highest point. Conversely, if devices 118 are positioned above the animal's eye level, the animal may be unaware of or unable to reach devices 118. Alternatively, if devices 118 are not easily accessed while the animal is at rest, the animal may not desire to exert the additional effort required to access such devices 118.

Consequently, most embodiments of animal apparatus 100 of the present invention are specifically sized so as to allow the animals to maintain eye level with devices 118. For example, in embodiments of the present invention created for birds, different animal apparatuses 100 may be created for birds of varying heights. An apparatus 100 sized for a parrot would not be intended for use by a smaller bird such as a parakeet. As such, various sizes of apparatus 100 may be created to suit different sizes of animals. Similarly, platform 102 of apparatus 100 may provide the ability to accommodate different sizes of devices 118, perches 106, and ladders 110, so that an existing apparatus 100 could be easily retrofit to accommodate larger or smaller animals, or change with the needs of growing animals.

Although FIG. 1 depicts the present invention in the form of an avian playgym for small to medium sized birds such as cockatiels, parrotlets, lovebirds, caiques, small conures, and meyers parrots, the present invention is not so limited. For example, the dimensions and the spatial orientation of the present invention could be altered to allow use of the playgym by larger birds such as African greys, amazons, pionus, or small-sized cockatoos as described in FIG. 2. Alternatively, the present invention may be configured for use by alternate animals by incorporating devices such as animal cages or other animal play or exercise devices such as Habitrail®, vivarium, or terrarium devices, or connection hardware for such devices. Alternatively, the components of the present invention may be configured so that the present invention may be joined to, or combined with, one or more units of the present invention, or similarly compatible apparatuses, so as to create a larger or more complex apparatus.

Turning next to FIG. 2, illustrated is another embodiment of the present invention in accordance with embodiments of the invention. Animal apparatus 200 includes, inter alia, platform 202, barriers 204, perch 206, receptacle perches 210, receptacles 208, device supporter 226, device supporter stands 214, devices 218, tree device 224, and roll device 222. The embodiment of the present invention depicted by FIG. 2 is differentiated from the embodiment depicted in FIG. 1 in that apparatus 200 and its various components are intentionally constructed on a larger scale so as to be able to accommodate larger animals. The larger scale of apparatus 200 allows the potential for the attachment of a greater quantity of, or larger and/or more complex, devices and accessories.

Platform 202 serves as a base for the additional components of animal apparatus 200 as well as a walkway that allows an animal such as a bird, ferret, hamster, rabbit, gerbil, guinea pig, cats, etc. to travel between the components of animal apparatus 200, and to benefit from the exercise value of the apparatus 200. Platform 202 and barriers 204 may be fabricated similarly to the embodiment of apparatus 100 as described in FIG. 1.

Device supporter 226 is attached to platform 202 via device supporter stands 214. However, other embodiments are envisioned where device supporter 226 is comprised of one continuous piece. In this embodiment, device supporter 226 could be removed and replaced with other similar device supporters that contain varied devices 218. In yet another embodiment, there may be an individual device supporter 226 and device supporter stands 214 for each device 218.

In the embodiment of the present invention depicted in FIG. 2, device supporter 226 includes a flat surface on the horizontal portion of device supporter 226. Device supporter 226 is an important aspect of the present invention in view of the instinctual pecking order and aversion to being preyed upon as described with respect to FIG. 1. The flat surface that comprises the horizontal portion of device supporter 226 is constructed of a slippery material such as rigid vinyl, acrylic or ultra high molecular weight polyethylene, and configured in a way that would cause the animal to be anxious standing upon device supporter 226. Alternatively, the horizontal portion of device supporter 226 could be constructed out of any material similarly described in FIG. 1, as well as acrylic, polyvinyl chloride (“PVC”), or the like that would discourage the animal from perching atop device supporter 226.

Alternate embodiments of device supporter 226 are envisioned. In one embodiment as depicted in FIG. 3, device supporter 226 includes impediments 312 extending at a 45 degree angle from the perimeter of device supporter 226. Impediments 312 prevent the animal from biting on the edge of device supporter 226 and pulling itself up onto device supporter 226. Impediments 312 also prevent the bird from climbing atop device supporter 226.

Attached to device supporter 226 are devices 218 (e.g., toys, wood blocks, etc.) via fasteners 220. Device supporter 226 and devices 218 may be fabricated similarly to the embodiment of apparatus 100 as described in FIG. 1. However, in this embodiment of the present invention, device supporter 226 and devices 218 may be fabricated on a larger scale to correspond with the larger scale of apparatus 200, as contrasted to the smaller scale embodiment depicted in FIG. 1.

Fasteners 220 shall be fabricated of sufficient size and strength to accommodate the larger devices 218 allowed by the larger scale of apparatus 200. In this embodiment of the present invention, device supporter 226 contains two devices 218. However, devices 218 may consist of any arrangement or configuration as similarly described in FIG. 1. While this embodiment contains two devices 218, other quantities, sizes, or complexity of devices 218 could be attached to device supporter 226 without departing from the present scope of the invention.

Although devices 218 may include any variations of the items described above, the inclusion of roll device 222 is an important aspect of the present invention. In this embodiment of the present invention, roll device 222 is attached to two of devices 218, but other embodiment are envisioned in which roll device 222 is attached to a single device 218 without departing from the spirit of the present invention. Roll device 222 is constructed such that paper, newspaper, paper tape such as adding machine tape or other similar material wound around a moveable roll can be ripped or torn off of the roll by the animal. The destruction of the paper, newspaper, paper tape such as adding machine tape, or other material on the paper rolls gives the animal a feeling of productivity and achievement. Similarly, other components of devices 218 such as wooden blocks, plastic toys and keys are constructed of disposable materials that can be destroyed by the animal to obtain the same feelings of productivity and achievement. The components of device 218 are assembled such that each component could be replaced if destroyed by the animal during use.

Also attached to platform 202 is tree device 224. Tree device 224 is constructed of many devices 218 attached together to form various branches of the tree. Tree device 224 allows the animal to have access to many different components of devices 218 at one location. In one embodiment of the present invention, tree device 224 would be rotatable to facilitate the animal rotating the entire tree device 224, thus allowing the animal easy access to the various facets of the device.

In one embodiment of the present invention, one perch 206 is attached to platform 202 but other quantities of perches 206 could be attached to platform 202 without departing from the scope of the present invention. Preferably, perch 206 is located at a height that allows the animal to be at eye level with devices 218 and tree device 224 when the animal is seated atop perch 206 or 210.

In one embodiment of the present invention, two receptacle perches 210 are attached to platform 202. Other numbers of receptacle perches 210 could be attached to platform 202 without departing from the spirit of the present invention. Preferably, receptacle perches 210 are located at a height that allows the animal to be at eye level with devices 218 and tree device 224 when the animal is seated atop receptacle perch 210. At the top of receptacle perch 210 are receptacles 208. Receptacles 208 are intended to hold food and water for the animal. Positioning perches 206 and receptacle perches 210 such that the animal is at eye level with devices 218 is an important aspect of the present invention due to pecking order and a natural aversion to being preyed upon as described above with respect to FIG. 1. Consequently, also as described above with respect to FIG. 1, most embodiments of animal apparatus 200 of the present invention are specifically tailored, originally or retrofitted by the owner, to allow the specific animal to maintain eye level with devices 218, roll device 222, and tree device 224.

While the present invention has been described with reference to one or more embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. An animal apparatus, said apparatus comprising:
at least one device for providing at least one of the group consisting of education, entertainment, amusement, exercise, and destructible material; and
at least one animal support;
wherein at least one of the group consisting of a position, a height, and a size of said animal support relative to at least one of the group consisting of a position, a height, and a size of said device is selected based upon the size of said animal; and
wherein said selection positions at least one of said devices at eye level of said animal whenever said animal is seated atop at least one of said animal supports.

2. An apparatus according to claim 1, said apparatus further comprising:
at least one device support for supporting at least one of said devices;
wherein said device support is constructed to prevent said animal from resting atop said device support.

3. An apparatus according to claim 1, said apparatus further comprising:
at least one device support for supporting at least one of said devices;
wherein said device support is at least one of the group consisting of slippery and unstable.

4. An apparatus according to claim 1, said apparatus further comprising:
at least one device support for supporting at least one of said devices;
wherein said device support includes at least one impediment; and
wherein said impediments restrict said animal from resting atop said device support.

5. An apparatus according to claim 4, wherein an angle between a surface of said impediment and a surface of said device support is 45 degrees.

6. An apparatus according to claim 1, wherein at least one of said devices includes materials that may be safely destroyed by said animal.

7. An apparatus according to claim 1, wherein at least one of said devices includes at least one length of material coiled about at least one spool.

8. An apparatus according to claim 7, wherein said material is paper.

9. An apparatus according to claim 2, wherein resting atop said device support causes anxiety for a typical one of said animals.

10. An apparatus according to claim 2, wherein said animal support is positioned to allow said animal to defecate and urinate while rested atop said animal support without soiling said device and said device supports.

11. An apparatus according to claim 1, said apparatus further comprising:
at least one receptacle for holding at least one of the group consisting of food and water.

12. An apparatus according to claim 11, wherein said animal support is positioned to allow said animal to defecate and urinate while rested atop said animal support without soiling said device, said device supports, and said receptacles.

13. An apparatus according to claim 1, wherein said animal support is at least one of the group consisting of a perch, a stand, a ladder, a swing, a floor, and a receptacle.

14. An apparatus according to claim 1, wherein said height of said animal support is higher than all other surfaces on which said animal may rest comfortably.

15. An apparatus according to claim 2, wherein said device is removably attached to said device support.

16. An animal apparatus, said apparatus comprising:
at least one device for providing at least one of the group consisting of education, entertainment, amusement, exercise, and destructible material;
at least one device support; and
at least one animal support;
wherein said device and said device support are constructed such that said animal may not rest comfortably upon said device and said device support.

17. An apparatus according to claim 16,
wherein at least one of the group consisting of a position, a height, and a size of said animal support relative to at least one of the group consisting of a position, a height, and a size of said device is selected based upon the size of said animal; and
wherein said selection positions at least one of said devices at eye level of said animal whenever said animal is seated atop at least one of said animal supports.

18. An apparatus according to claim 16, wherein said animal support is positioned to allow said bird to defecate and urinate while rested atop said animal support without soiling said device and said device supports.

19. A playgym for a bird, said playgym comprising:
at least one toy for providing at least one of the group consisting of education, entertainment, amusement, exercise, and destructible material;
at least one toy suspension device; and
at least one perch;
wherein said toy and said toy suspension device are constructed such that said bird may not rest comfortably upon said toy and said toy suspension device.

20. A playgym according to claim 19, wherein said perch is positioned to allow said bird to defecate and urinate while rested atop said perch without soiling said toys and said toy suspension devices.
